(19) United States
(12) Patent Application Publication
(10) Pub. No.: US 2004/0048941 A1
(43) Pub. Date: Mar. 11, 2004

(54) Process for the Production of void-free, pinhole-free polyurethane block foam

(76) Inventors: Reiner Raffel, Siegburg (DE); Jurgen Wirth, Koln (DE); Wolfgang Pawlik, Koln (DE); Martin Schamberg, Hennef (DE)

Correspondence Address: WILLIAM F. HALLISEY, 317 MENAUHANT ROAD, EAST FALMOUTH, MA, 02536

(21) Appl. No.: 10/656,346

(22) Filed: Sep. 5, 2003

(30) Foreign Application Priority Data
Sep. 11, 2002 (DE) 10242101.3

(51) Int. Cl. C08G 18/00

(52) U.S. Cl. 521/155

(57) ABSTRACT

The present invention relates to a process for the continuous production of polyurethane foam from at least one polyol component and at least one isocyanate component in the presence of water as a blowing agent and optionally further additives, in which, the process steps of mixing and nucleation are separated spatially from one another, such that the components are mixed with one another initially, and bubble nuclei are generated in the polyurethane reaction mixture.

### FIELD OF THE INVENTION

The present invention relates to a process for the continuous production of polyurethane foam, in particular polyurethane block foam, in the presence of water as a blowing agent, in which the process steps of mixing and nucleation are carried out separately from one another.

### BACKGROUND OF THE INVENTION

The process for the production of polyurethane foam in the presence of water as a chemical blowing agent is described in EP-A1-565 974, for example. In this process, the polyol and isocyanate as well as water and optionally further additives, are supplied with continuous dispensing to a mixing chamber and are there mixed by a stirrer-type mixer. The mixture is then discharged. Carbon dioxide which serves as a blowing gas and brings about the foaming of the polyurethane, arises in the reaction between isocyanate and water.

Although the function of the stirrer is to mix the components with one another, it has the additional function of releasing in the mixing chamber, as very fine gas microbubbles, the gas, such as air or nitrogen, which is dissolved in the components in small amounts as a bubble nucleating agent. The microbubbles function as bubble nuclei.

Depending on the gas content dissolved as the bubble nucleating agent in the components, and depending on the pressure in the mixing chamber, the dissolved gas content is released at the stirring elements by shear forces and cavitation and thus forms the nucleus cells for the CO₂ blowing gas which is generated chemically during the course of the reaction. Owing to the peripheral velocities which differ greatly over the radius, however, this takes place in a highly uncontrolled and unplanned manner, such that a highly non-homogeneous bubble spectrum arises. regulate the cell count in the polyurethane foam which is generated, it is also possible to dissolve in the components, preferably in the polyol and/or the isocyanate component, larger quantities of physically dissolved blowing gas such as low-boiling liquids or CO₂. However, if loadings with physically dissolved blowing gas are high, this results in the mixture frequently being interspersed with large numbers of coarse bubbles when it is discharged, which subsequently result in voids in the foam or, alternatively, streaks and textures.

A further problem resides in the possibility of a gas phase separation at the stirrer shaft because, owing to their lower density, the gas bubbles migrate inwards to the stirrer shaft as a result of the centrifugal force field. Individual larger bubbles can then be entrained from this gas phase by the flow of the polyurethane reaction mixture, and these likewise result in voids or pinholes, i.e., flaws, in the foam.

The centrifugal force in the mixing chamber also gives rise to another problem. Depending on the type of stirrer and the stirrer speed, the pressure in the mixing chamber is markedly greater in the outer than the inner region. The pressure level is, however, an essential parameter for the release of bubble nuclei. Targeted nucleation, that is to say, a targeted release of bubble nuclei, becomes markedly more difficult as a result of this effect. Moreover, in this process the stirrer cannot simply be optimized in terms of mixing of the components, because the optimized mixing can result in a generation of bubble nuclei which is not targeted.

Another problem occurs if targeted cell count regulation is attempted by an additional loading of one component with a bubble nucleating agent such as air or nitrogen. Although, it is possible in principle to increase the cell count at a given mixing chamber pressure by dissolving gas which acts as a bubble nucleating agent in one of the reaction components, in this case, pinholes and voids also arise simultaneously in the foam that is generated. While increasing the mixing chamber pressure eliminates this effect, it also results in coarser cells in the polyurethane foam that is generated. Defect-free fine cells can be obtained only at low loadings with dissolved bubble nucleating agent and at low mixing chamber pressures. The mixing chamber pressures that are obtainable are, however, dependent on the type of stirrer, the viscosity of the mixture, the throughput and the stirrer speed.

### SUMMARY OF THE INVENTION

The present invention breaks these interdependencies and makes possible good mixing of the reaction components and likewise targeted generation of bubble nuclei. To achieve this, the process steps of mixing and nucleation are separated spatially from one another, such that the components are mixed with one another initially, and bubble nuclei are subsequently generated in the polyurethane reaction mixture. The number of bubble nuclei generated is regulated by adjustment of the pressure.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

The present invention relates to a process for the continuous production of polyurethane foam from at least one polyol component and at least one isocyanate component in the presence of water as a blowing agent and optionally further additives, in which

a) the polyol component, the isocyanate component, the water and optionally the further additives are metered into the mixing chamber of a mixing unit and are therein mixed at pressures of from 3 to 200 bar, preferably from 5 to 200 bar to form a polyurethane reaction mixture,

b) the polyurethane reaction mixture is atomized in a pressure-reduction body with pressures of from 3 to 200 bar, preferably from 5 to 200 bar to generate bubble nuclei, the pressure is adjusted in the direction of flow downstream of the pressure-reduction body by a throttle body, and the number of bubble nuclei which are generated is thus regulated, and

c) the polyurethane reaction mixture containing bubble nuclei is caused to flow out through the throttle body and is applied to a substrate on which it foams and cures.

The water and optionally the additives may be conveyed into the mixing chamber as separate streams, or they may first be introduced in whole or in part into the at least one polyol component and/or the at least one isocyanate component and mixed therewith, and then be conveyed into the mixing chamber together with the latter at least one polyol component and/or the at least one isocyanate component.

Those diisocyanates and/or polyisocyanates which are known in polyurethane chemistry, such as, for example, toluene diisocyanate (TDI) or isocyanates of the diphenyl methane series (MDI), are preferred as the isocyanate component.

Those polyols having hydrogen atoms that are reactive vis-a-vis isocyanate groups and which are known in polyurethane chemistry, such as polyethers, polyesters or polyamines, are preferred as the polyol component.

Those auxiliary substances and additives which are known in polyurethane chemistry, such as, for example, catalysts, emulsifiers, stabilizers, reaction retardants, pigments, dyes, flame retardants, additional blowing agents or fillers, may be included as additives.

Any suitable mixing units may be used as a mixing unit. Stirrer-type mixers or static mixers or combinations thereof are preferred. Conveyor belts, which may be provided with covering layers, or molds or any other common foaming supports, may be employed, for example, as a substrate on which the polyurethane reaction mixture foams and cures.

The uncontrolled generation of bubble nuclei in the mixing chamber may preferably be prevented by carrying out the mixing at high pressures such that even low-pressure zones and local shear gradients cannot lead to the release in the mixing chamber of the gas, such as air or nitrogen, which is dissolved in the components as a bubble nucleating agent and the CO₂ which arises from the chemical reaction between isocyanate and water. The pressures in the mixing chamber are between 3 and 200 bar, preferably between 5 and 200 bar and more preferably between 10 and 100 bar. The pressures in the mixing chamber may be in an amount ranging between any combination of these values, inclusive of the recited values.

In the subsequent atomization of the polyurethane reaction mixture a particularly narrow bubble spectrum can be generated with extremely fine bubble nuclei, in comparison with nucleation by stirrers. For this purpose the atomization is effected preferably at pressures of from 3 to 200 bar, preferably at pressures of from 5 to 200 bar and more preferably at pressures of from 10 to 100 bar. The pressures in the pressure-reduction body may be in an amount ranging between any combination of these values, inclusive of the recited values.

Preferably, a bubble nucleating agent may be dissolved in one or more of the components, for example in the polyol component and/or the isocyanate component, before mixing the components in the mixing chamber. Preferred bubble nucleating agents include air and nitrogen. The subsequent mixing in the mixing chamber is effected at pressures above the solution pressure of the gas content that is dissolved in the mixture or the components, such that no bubble nucleating agent and no CO₂ arising from the chemical reaction between isocyanate and water is released in the mixing chamber.

The bubble nucleating agent may also be injected into the mixing chamber and dissolved there. Preferably, the bubble nucleating agent injected into the mixing chamber is dissolved completely there.

However, the quantities of air or nitrogen which are dissolved in the at least one polyol component and/or the at least one isocyanate component during storage are frequently sufficient for the formation of bubble nuclei.

In the direction of flow downstream of the mixing chamber, the pressure is reduced by suitable pressure-reduction bodies, such that a targeted bubble nucleation takes place. The presence of sufficiently high shear rates and of shear edges and a reduction to a pressure level below the solution pressure of the dissolved gas content in the reaction mixture are important for this. The reduction is preferably effected abruptly.

One or more nozzles or nozzle fields are preferred as pressure-reduction bodies for the atomization and the generation of bubble nuclei. A nozzle field is understood herein to mean a plurality of nozzle-like or orifice-like openings, which may be arranged adjacent to one another and through which parallel flow takes place. Orifices, sieves or perforated plates are, likewise suitable. In a preferred embodiment, these openings, and hence the speeds at which flow takes place through these openings, are adjustable. This may be achieved, for example, by pintle-type nozzles or perforated plates that are displaceable or twistable in relation to one another. The number of gas nuclei generated may be regulated or controlled in this manner.

The pressure in the direction of flow downstream of the pressure-reduction body is adjusted by an adjustable throttle body. The number of gas nuclei generated is regulatable by this means. Depending on the type and quantity of the gas utilized as a nucleating agent, the pressure level between the pressure-reduction body and the throttle body is within a range having a maximum of 20 bar, preferably within the range 0.1 to 20 bar, more preferably within the range 0.1 to 10 bar and most preferably within the range 0.2 to 5 bar.

Throttle valves or other suitable adjustable throttle devices may be used as throttle bodies. Diaphragm valves or pinch valves are preferably employed. An advantage of the decoupling of the process steps of mixing and nucleation is that static mixers may be utilized as a mixing unit. Because a static mixer is able to achieve good mixing only when the pressure difference is sufficient, where a static mixer is used, targeted generation of bubble nuclei is not possible without decoupling the process steps of mixing and nucleation. A static mixer generates in the mixture neither low-pressure zones and cavitation zones nor shear gradients adequate for the achievement of a sufficiently fine nucleation. The gradual pressure reduction in the static mixer and the relatively low shear forces in the flow through the static mixer result in a bubble count that is only relatively low and a highly non-homogeneous bubble spectrum.

If, however, a suitable pressure-reduction body is switched downstream of the static mixer, the pressure level in the static mixer, in particular at the outlet of the static mixer, can be maintained at a level sufficiently high such that no gas is released. As a result, the static mixer can be optimized with respect to mixing with no negative influence on the generation of the bubble nuclei.

The invention furthermore relates to an apparatus for the continuous production of polyurethane foam, made of a mixing unit having a mixing chamber and supply lines for the reaction components and a discharge opening for the polyurethane reaction mixture, wherein a pressure-reduction body connects to the discharge opening and an adjustable throttle body is arranged in the direction of flow downstream of the pressure-reduction body.

A stirrer-type mixer or static mixing elements or combinations thereof may preferably be used as a mixing unit.

One or more nozzles or nozzle fields as well as orifices, sieves or perforated plates are preferred as pressure-reduction bodies.

Throttle vales or other suitable adjustable throttle devices are preferred as throttle bodies. Diaphragm valves or pinch valves may preferably be employed. Although the invention has been described in detail in the foregoing for the purpose of illustration, it is to be understood that such detail is solely for that purpose and that variations can be made therein by those skilled in the art without departing from the spirit and scope of the invention except as it may be limited by the appended claims.

What is claimed is:

1. A process for the continuous production of polyurethane foam from at least one polyol component and at least one isocyanate component in the presence of water as a blowing agent and optionally further additives, comprising the steps of:
metering into a mixing chamber of a mixing unit and mixing therein at pressures of from about 3 to about 200 bar to form a polyurethane reaction mixture, the at least one polyol component, the at least one isocyanate component, the water and optionally the further additives;
generating bubble nuclei in the polyurethane reaction mixture by atomization thereof in a pressure-reduction body at pressures of from about 3 to about 200 bar, wherein the pressure is adjusted in the direction of flow downstream of the pressure-reduction body by a throttle body;
causing the polyurethane reaction mixture containing bubble nuclei to flow out through the throttle body; and
applying the polyurethane reaction mixture containing bubble nuclei to a substrate for foaming and curing.

2. The process according to claim 1, wherein the mixing in the mixing chamber is performed at pressures of from about 5 to 200 bar and wherein the atomization is performed at pressures of from 5 to 200 bar.

3. The process according to claim 1, wherein the mixing unit is selected from the group consisting of stirrer-type mixers, static mixing elements and combinations thereof.

4. The process according to claim 1, wherein the pressure-reduction body comprises one or more nozzles or orifices.

5. The process according to claim 4, wherein the cross-sectional area of the one or more nozzles or orifices openings is adjustable.

6. The process according to claim 1, wherein the throttle body comprises a diaphragm valve or pinch valve.

7. The process according to claim 1, wherein the maximum pressure between the pressure-reduction body and the throttle body is about 20 bar.

8. The process according to claim 1, wherein at least one bubble nucleating agent is dissolved in the polyol component and/or the isocyanate component in the mixing chamber before the mixing.

9. The process according to claim 1, wherein at least one bubble nucleating agent is injected into the mixing chamber and is dissolved there.

10. In an apparatus for the continuous production of polyurethane foam, comprising a mixing unit having a mixing chamber and supply lines for the reaction components and a discharge opening for the polyurethane reaction mixture, the improvement comprising connecting a pressure-reduction body to the discharge opening and arranging an adjustable throttle body in the direction of flow downstream of the pressure-reduction body.
